(19) United States
(12) Patent Application Publication
(10) Pub. No.: US 2017/0228787 A1
(43) Pub. Date: Aug. 10, 2017

(54) PROVIDING CONTENT ITEMS BASED ON UPCOMING USER ACTIONS

(71) Applicant: Google Inc., Mountain View, CA (US)

(72) Inventor: Luis German Benavides Oyaga, San Francisco, CA (US)

(21) Appl. No.: 14/321,676

(22) Filed: Jul. 1, 2014

(51) Int. Cl. G06Q 30/02

(52) U.S. Cl. CPC G06Q 30/0264

(57) ABSTRACT

Methods, systems, and apparatus, including computer programs encoded on a computer storage medium, for providing content items are disclosed herein. In one aspect, a method includes receiving a content item request specifying an upcoming user action that is scheduled to be performed at a future time that is within a specified amount of time after the content item request is received. In response, a determination is made that a content item has distribution criteria corresponding to a complementary product or service of the user action and specifying that the content item is eligible to be provided in response to content item requests received during the specified amount of time prior to the future time when the user action is scheduled to be performed. In response to the content item request and based on the determination, the content item is provided for presentation at a user device.

### BACKGROUND

The Internet enables access to a wide variety of resources. For example, video, audio, webpages directed to particular subject matter, news articles, images, and other resources are accessible over the Internet. The wide variety of resources that are accessible over the Internet has enabled opportunities for content distributors to provide content items with resources that are requested by users. Content items are units of content (e.g., individual files or a set of files) that are presented in/with resources (e.g., web pages, applications, etc.). An advertisement is an example of a content item that advertisers can provide for presentation with particular resources, such as web pages and search results pages. An advertisement can be made eligible for presentation with specific resources and/or resources that are determined to match specified distribution criteria, such as distribution keywords.

### SUMMARY

This specification describes technologies relating to providing content items based on an upcoming user action.

In general, one innovative aspect of the subject matter described in this specification can be embodied in methods that include the actions of receiving a content item request specifying an upcoming user action that is scheduled to be performed at a future time that is within a specified amount of time after the content item request is received; determining, in response to receiving the content item request, that a content item has distribution criteria corresponding to a complementary product or service of the user action and specifying that the content item is eligible to be provided in response to content item requests received during the specified amount of time prior to the future time when the user action is scheduled to be performed; and providing, in response to the content item request and based on the determination, the content item for presentation at a user device. Other embodiments of this aspect include corresponding systems, apparatus, and computer programs, configured to perform the actions of the methods, encoded on computer storage devices.

These and other embodiments can each optionally include one or more of the following features. Aspects can include receiving data specifying the user action and the specified amount of time; providing the data to one or more content item providers; and receiving, from at least one of the content item providers, distribution criteria specifying a bid for providing a content item of the at least one content item provider in response to content item requests that specify that the user action and that are received during the specified amount of time prior to a future time when the user action is scheduled to be performed by a user; and selecting the content item based at least on the received distribution criteria.

In some aspects, the user action includes attending an event. Aspects can include selecting, based on at least one of the event and a role of the user with respect to the event, the content item from a set of content items that have distribution criteria corresponding to a complementary product or service.

Aspects can include determining that the user action is scheduled to be performed based on previous user actions performed with respect to a first application and determining that the content item is eligible to be provided by a second application that is different from the first application. The content item can present a link to install the second application in response to determining that the second application is not installed on the user device.

In some aspects, providing the content item includes providing data that causes a notification of the content item to be displayed at the user device. Interaction with the notification can cause the content item to be displayed at the user device.

Aspects can include determining that the user action is scheduled to be performed based on scheduled attendance at an event at a particular time. In some aspects, the content item request is initiated by an application in response to determining that the user action is scheduled to be performed based on previous user interaction with the application. In some aspects, the user action is an offline user action performed without use of the application or the user device.

Particular embodiments of the subject matter described in this specification can be implemented so as to realize one or more of the following advantages. Content items that are of interest to a user may be provided at a time that is useful to the user. Contextual data stored by applications, such as mobile apps, can be used to provide content items that are of interest to users and at an appropriate time for the user. Economic incentives can be provided to advertisers and/or application developers by providing content items based on anticipated needs or upcoming actions of users. Such content items can include content or links to resources that assist the users in fulfilling their needs and/or completing the upcoming actions.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example environment in which a content distribution system provides content items.

FIG. 2 shows illustrations of an example user interface that displays a content item.

FIG. 3 shows illustrations of an example user interface that displays a content item.

FIG. 4 is a flow chart of an example process for requesting and presenting a content item.

FIG. 5 is a flow chart of an example process for providing a content item.

FIG. 6 is a block diagram of an example computer system.

Like reference numbers and designations in the various drawings indicate like elements.

### DETAILED DESCRIPTION

Content items can be provided based on user actions that have been performed, that are being performed, and/or that are scheduled to be performed, e.g., within a specified amount of time. The user actions can be identified based on previous actions performed by the user and/or data stored by one or more applications, such as one or more mobile apps. For example, a user may book a flight using a travel-based application and the application may store data regarding the flight. At a particular time prior to the flight, a content item for a taxi or car sharing service may be provided to the user. For example, the content item may be displayed in/with the travel-based application, an application for a taxi service, and/or separate from the applications based on a determination that the flight is scheduled to depart within three hours of the current time.

The content item provided for a user action may be directed to a complementary product or service that complements the user action. For example, if the user action is to attend a party, an advertisement for a gift for the host may be provided. The content item may also be selected based on the user's role in the event. For example, a content item for a gift may be provided to a guest of a party, while a content item for a catering service may be provided to a host of a party.

Application developers or other entities related to an application can specify user actions for which content items may be provided. For example, the developer of a travel-based application may specify pre-departure actions for which content items may be provided based on a user's scheduled departure being within a specified amount of time. An event scheduling application may specify event actions for which content items may be provided to users attending the event, for example, based on the event occurring within a specified amount of time. In another example, a ticket purchasing application may specify event actions for which content items (e.g., for nearby restaurants) may be provided to users attending a ticketed event, such as a movie, concert, or sporting event.

Content item providers can configure campaign or distribution criteria for their content items such that the content items are eligible to be provided for particular user actions, user actions in particular locations, and/or categories or types of user actions. For example, a restaurant owner may configure criteria such that coupons are provided to users that have purchased movie tickets at a particular theater, e.g., a theater that is located near the restaurant. The coupons may be provided at a specified amount of time before the movie is scheduled to start.

Techniques described herein can enable advertisers (or other content item providers) and application developers to realize economic benefits by anticipating the needs or upcoming actions of users and providing content items that help the user fulfill the needs to complete the action. For example, an application may anticipate that a user will need a ride to the airport based on the user purchasing a plane ticket and the flight leaving within a specified amount of time. A taxi service may realize an economic benefit by having a content item for the service provided to users that may need a ride to the airport and the users booking a taxi in response to receiving the content item. In addition, if the user does not have an application for the taxi service installed on their device, the user may receive a link to download the application.

For situations in which the systems described here collect information about users, or may make use of information about users, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that certain information about the user is removed. For example, a user's identity may be treated so that no identifying information can be determined for the user, or a user's geographic location may be generalized where location information is obtained (such as to a city, ZIP code, or state level), so that a particular location of a user cannot be determined. Thus, users may have control over how information is collected about them and used by a content server.

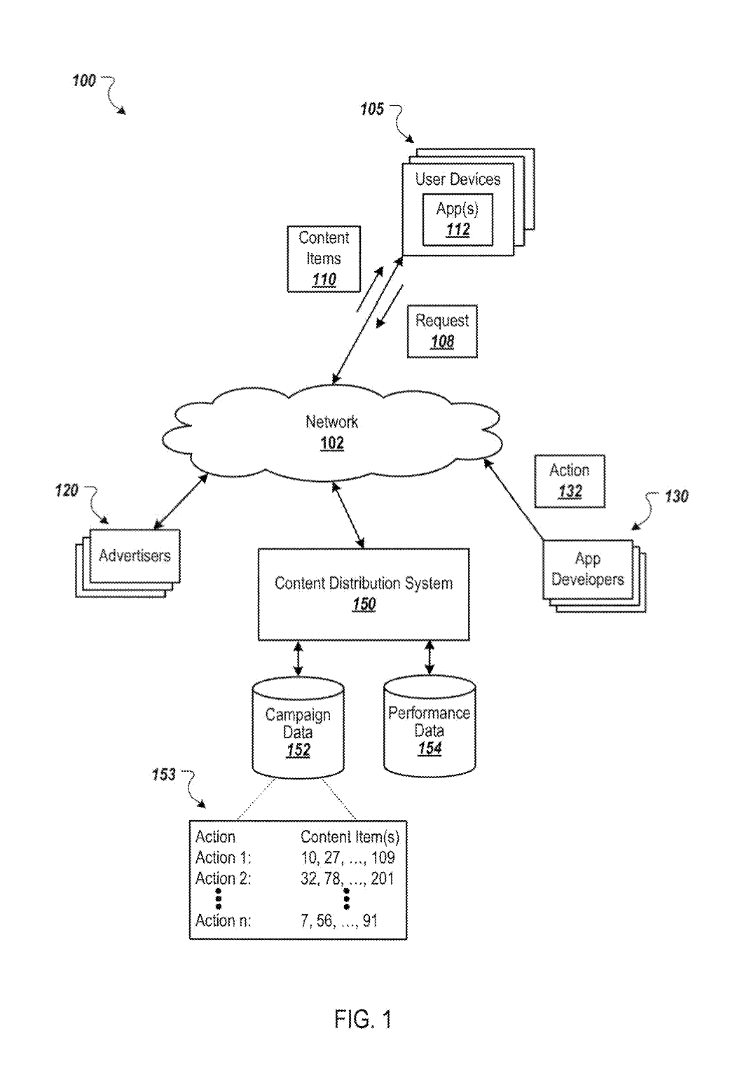

FIG. 1 is an example environment 100 in which a content distribution system provides content items. The example environment 100 includes a network 102 such as a local area network (LAN), wide area network (WAN), the Internet, or a combination thereof. The network 102 connects user devices 105, advertisers 120, application developers 130, and the content distribution system 150. The example environment 100 may include many user devices 105, advertisers 120, and application developers 130.

A user device 105 is an electronic device that is capable of executing one or more applications 112, e.g., mobile apps. Example user devices 105 include mobile computing devices, e.g., smartphones, tablet computing devices, and/or smart watches, and personal computers. Applications executing on the user device 105 can cause the user device 105 to send, to the content distribution system 150, content item requests 108 for content items to display at the user device 105. Content items can include advertisements, recommendations, text, images, videos, newsletters, coupons, documents, or other types of content items. For example, a social networking application may request advertisements for presentation to users viewing social networking content using the social networking application.

A content item request 108 can include data regarding a user action that has been performed, that is being performed, and/or that is likely to be performed (e.g., scheduled to be performed) within a specified amount of time. For example, an application 112 may be configured to send a content item request 108 for one or more content items in response to determining that a user is scheduled to perform a particular action, e.g., at a particular time or within a specified amount of time from the current time. In a particular example, a travel-based application may be configured to request content items (e.g., content items related to ground transportation) in response to determining that the user is scheduled to take a flight that departs within two hours of the current time. The user actions can include offline actions, e.g., actions taken without the use of the application 112 or the user device 105, such as going to the airport or to a restaurant.

The data regarding a user action can specify the user action, a category of the user action, and/or contextual data related to the user action. For example, a travel-based application may determine that a user is likely to be traveling to a particular airport within the next three hours based on a flight from that airport that the user has booked using the travel-based application. In response, the travel-based application may send a content item request 108 that specifies the action of going to the particular airport within three hours, a category of traveling or flying, and/or contextual data, such as the airport, the time of the flight, the destination of the flight, and/or whether the flight has been delayed.

A content item request 108 can also include other data, such as data regarding content item slots in which the content items will be presented (e.g. size or type of content item slot), location data that indicates a location of the user device 105 (e.g., using GPS data), other contextual data, data specifying the application sending the request, and/or data specifying other applications installed on the user device 105. The data of the content item request 108 may be based on the application submitting the request or the type of application sending the request. For example, an event-based application or a social networking application that enables users to set up events and invite other users to the events may provide data regarding a user's role (e.g., host or guest) at the event, the number of people attending the event, and/or whether any social networking contacts of the user are attending the event.

Although the content item requests 108 can be for particular user actions, the content items requests 108 need not provide any user identifiable information. For example, the content item requests 108 can indicate that a user, but not a particular user, is scheduled to take a flight or attend a movie within a specified amount of time.

The content distribution system 150 can select content items 110 to provide in response to content item requests 108 and provide the selected content items 110 to the user device 105. The content distribution system 150 allows application developers 130 to specify user actions 132 for which content items may be presented. For example, an application developer 130 for a travel-based application may specify user actions related to traveling using the travel-based application. Example travel-based user actions include a user going to an airport within a specified amount of time; a user's flight being delayed and the length of the delay; and a user boarding a cruise ship within a specified amount of time, to name just a few.

A developer of an event scheduling application (or an application that enables users to invite users to events, such as a social networking application) can specify actions related to an event a user is scheduled to attend. Example user actions can include a user attending an event of a particular type; a guest attending an event of a particular type; and/or a host hosting an event of a particular type. The particular type of event may specify a dinner party, birthday party, office party, or other appropriate type of event.

A developer of a ticket purchasing application can specify actions related to an event for which a user has purchased a ticket. For example, user actions for a movie ticket purchasing application may include a user going to see a movie; a user going to see a particular movie at a particular theater; and a user going to see a particular type of movie (e.g., action, drama, or comedy). Many other appropriate user actions can be specified for the applications described above and for many other types of applications.

The application developers 130 can also specify a time period (or amount of time) with respect to the time at which the user action is likely to, or scheduled to, occur. The specified amount of time can be used to trigger the request for a content item 110. For example, the specified amount of time for user actions related to traveling to an airport to make a scheduled flight may be two to three hours to allow the user time to receive the content item, request a ride to the airport, and make it to the airport in time to make the flight. This allows the users to receive relevant content items at a time that is beneficial to the user.

User actions can also be specified for actions that a user may be interested in taking based on their past actions. For example, a user may have downloaded or listened to a particular musician's music using a music application. If that musician schedules a concert near the user (e.g., within a specified distance from the user), the music application may determine that the user may be interested in attending the concert. In response, the user action of attending the musician's concert may be associated with the user. This user action may have a specified time period for causing the music application to request a content item related to the concert. For example, the user action may trigger a content item request a week before tickets for the concert are offered for sale.

In some implementations, the user actions are specified using a structured format. For example, each user action may specify a particular user action (e.g., attending a particular football game) or a category of user action (e.g., event or travel) and a time period for use in triggering the request or presentation of a content item. The structured format may allow for additional data, e.g., contextual data, that can be configured by the application developers 130. For example, a developer of an event-based application may include a user's role in an event as part of a defined action.

The application developers 130 may configure their applications to cause a user device on which the application is executing to submit a content item request 108 in response to determining that a specified user action is likely to, or scheduled to, be performed by a user of the user device. For example, the developer of a travel-based application may configure the application to cause the user device to request content items in response to determining that the user is going to take a flight in three hours. Each user action may be associated with criteria for the user action. For example, the criteria for a user action of going to an airport may be the purchase of an airline ticket that departs from the airport. In another example, the criteria for attending an event may be accepting an invitation to the event or purchasing a ticket to the event. If the user's previous activity matches the criteria for the user action, the application may cause the user device to submit a content item request that specifies the user action.

The application developers 130 can also provide data specifying the user actions to the content distribution system 150. The content distribution system 150 allows advertisers 120 and/or other content item providers to define distribution criteria that specify user actions and/or categories of user actions for which they would like for their content items to be provided or for which their content items are eligible to be provided. For example, a taxi service may select to have its content items provided in response to certain user actions in which a user may be interested in taking taxi. In a particular example, a taxi service may specify in distribution criteria that one or more of its content items are eligible to be provided in response to content item requests that specify the user action of going to an airport or the user action of going to a concert or other event.

The distribution criteria for a content item may also specify that the content item is eligible to be provided in response to content item requests received during a specified amount of time prior to a future time when the user action is likely to, or schedule to, occur. For example, the taxi service may specify in distribution criteria that one or more of its content items are eligible to be provided in response to content item requests that specify the user action of going to an airport in two hours or going to a concert or other event in two hours.

A complementary product or service of a content item may be different from or independent of the user action. For example, the user action may be completed without the complementary product or service. In a particular example, a user may be scheduled to take a flight in three hours and, in response, a content item for a taxi may be provided to the user's device. The user can complete the user action of going to the airport without the use of the taxi, e.g., the user may have arranged other transportation or may be in walking distance of the airport.

The advertisers 120 can also specify distribution criteria for products or services that complement user actions. For example, an advertiser 120 may specify that a product or service offered by the advertiser complements a particular user action. Or, the content item distribution system 150 may identify products or services of advertisers 120 that complement particular user actions. If a product or service is deemed to complement a particular user action, content items for the particular product or service may be eligible to be provided in response to content item requests 108 that specify the user action.

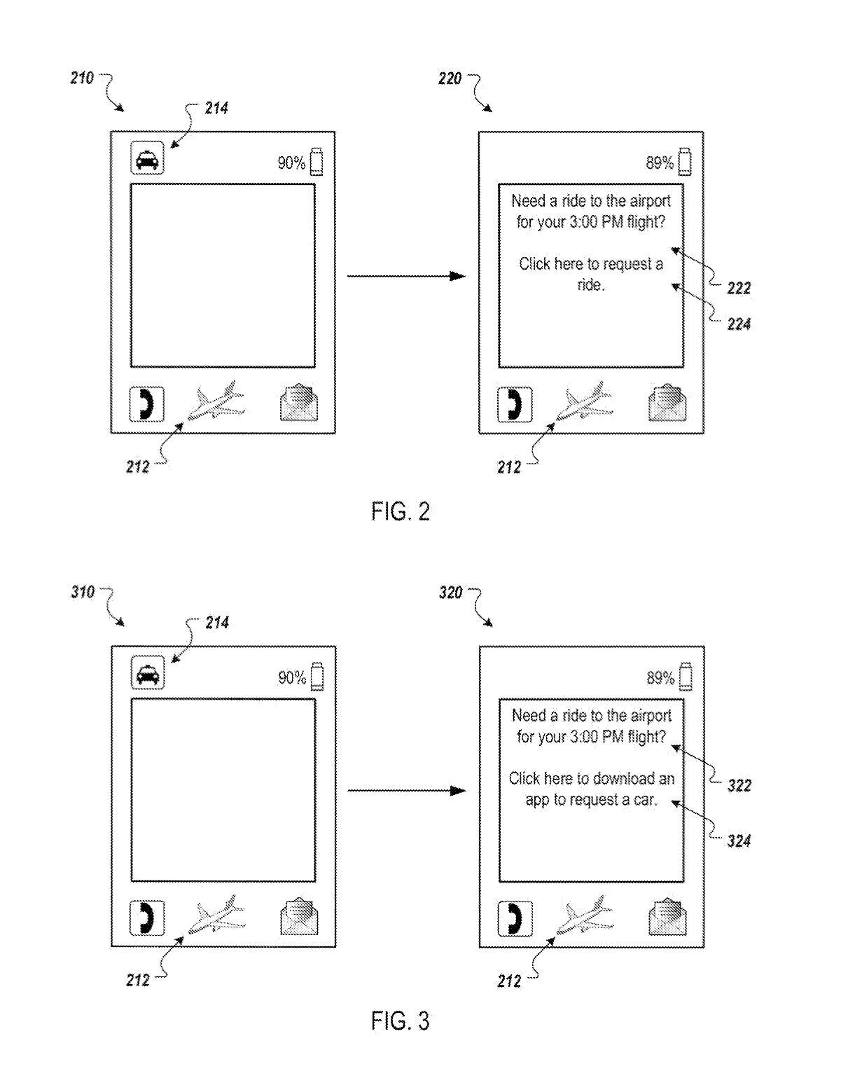

The advertisers 120 may include application developers 130. Continuing the previous taxi example, an application developer 130 for a taxi service may want to provide a content item that advertises its application to users that are scheduled to take a flight within a specified amount of time. As shown in FIGS. 2 and 3 and described in more detail below, an advertisement for using the taxi service's application may be provided if the user's device has the application installed thereon. If the user's device does not have the application, content item for installing the application may be provided to the user's device.

In some implementations, the advertisers 120 select user actions that have been specified by the application developers. For example, an inventory of user actions that have been specified by the application developers 130 may be provided to the advertisers 120. The advertisers 120 may select one or more user actions for a content item and, in some implementations, provide a bid for the user action.

The campaign criteria can also specify particular contextual data about a user action or user device 105 on which content items are to be presented. For example, the advertisers 120 may define location-based rules to serve content items to user devices 105 that are within particular geographic areas. Continuing the previous taxi example, the taxi service may specify locations in which the taxi service operates, along with the user actions for which its content items are eligible. For example, the taxi service may bid on user actions of going to an airport in a particular city in which the taxi service operates. In this example, the content items of the taxi service may only be eligible to be provided in response to content items that are received from user devices located in the locations specified by the contextual data.

The content distribution system 150 includes a data storage system that stores campaign data 152 and performance data 154. The performance data 154 stores data indicating the performance of the content items that are served. Such performance data can include, for example, click-through rates for content items, the number of impressions for content items, and the number of conversions for content items (e.g., purchase of a product in response to the display of an advertisement or download of a mobile app or other application). Other performance data can also be stored.

In some implementations, click data and conversion data can be predicted. For example, machine learning techniques can be used to predict the probability that a content item will be selected and/or the probability that a content item will result in a conversion. The machine learning techniques may be trained using historical performance data for one or more users.

The campaign data 152 stores content items (e.g., advertisements, recommendations, etc.), campaign criteria, bid values for content items, and budgeting information for advertisers 120. In some implementations, the campaign data 152 includes a user action index 153. The user action index 153 can include, for one or more applications, data specifying user actions for which content items may be provided and/or categories of user actions for which content items may be provided. The user action index 153 can also include, for each user action or category of user action, data specifying content items that are eligible to be provided in response to content item requests 108 that specify the user action. For example, multiple restaurants may bid to have their content item presented in response to content item requests that specify that a user is going to a particular movie theater within two hours of a current time. In another example, multiple taxi and/or car sharing services may bid to have their content items presented on response to content item requests that specify that a user is scheduled to take a flight at a particular airport in the next three hours.

In some implementations, the content distribution system 150 may select content items that are eligible for a content item request. For example, the content distribution system 150 may select content items based on the user action, the category of user action, and/or other data received in the content item request.

The campaign data 152 and the performance data 154 can be used as input parameters to a content item selection process, e.g., an advertisement auction. For example, the content distribution system 150, in response to determining that a user action specified by a content item request is likely or scheduled to occur within a specified time period from a current time or a time at which the content item request is received, can conduct an action to select content items 110 that are provided in response to the content item request 108. The content items 110 that are eligible to be provided in response to the user action specified by the content item request 108 can be ranked according to a rank score. The rank score may be proportional to a value that is determined based on a content item bid and one or more parameters specified in the performance data 154. One or more of the content items may be selected and provided to the user device 105 based on the rank scores.

In some implementations, the content distribution system 150 may use employ spam prevention measures. For example, the content distribution system 150 may limit the number of content items provided to each particular user during a time period. The content distribution system 150 may also consider the quality of content items provided to the user, the probability of the user interacting with the content item, and/or other appropriate data when determining whether to provide a content item. For example, if the user has received a threshold amount of content items in the last six hours, the content distribution system 150 may provide a content item if the selected content item is high quality (e.g., has a quality measure that exceeds a threshold) or has a high probability of being selected (e.g., greater than a threshold probability).

In some implementations, a content item application may execute on the user device to facilitate the requesting and presentation of content items. For example, a content item application may interact with one or more applications executing on the device to determine when a user action associated with an application has been triggered (e.g., based on the user action being scheduled to occur within an amount of time specified by the user action). In response, the content item application can submit a content item request 108 to the content distribution system 150. Upon receiving the content item 110, the content item application can cause the content item 110 to be presented.

The content item(s) 110 provided to the user device 105 may be presented with the application from which the user action was identified. The content item may also be presented separate from the application. For example, the content item may be related to another application rather than the application that triggered the user action. In a particular example, a content item for a taxi service may be selected for presentation in response to a travel application triggering a user action related to a user's upcoming flight. If the user's device has the taxi application installed and executing thereon, the content item may be provided using the taxi application. If not, a content item for downloading the taxi application or a content item that links to a web page of the taxi application may be provided.

FIG. 2 depicts block diagrams of example user interfaces 210 and 220 that display a content item. In the example user interface 210, a content item related to a taxi service has been provided to a user device. For example, a travel-based application 212 may submit a content item request for a content item in response to determining that a user associated with the user device is scheduled to take a flight in three hours. The user device may display a notification 214 that informs the user that a content item is available for viewing. To view the content item, the user may interact with (e.g., select) the notification 214.

In response to the user interaction with the notification 214, the user interface 220 presents the content item 222. In this example, the content item 222 includes a link 224 that links to an application that enables the user to request a ride to the airport. For example, the content item 222 that includes the link 224 may be presented based on the user's device already having the application installed thereon.

FIG. 3 depicts block diagrams of example user interfaces 310 and 314 that display a content item. In the example user interface 310, a content item related to a taxi service has been provided to a user device, similar to that of the example illustrated in FIG. 2. For example, a travel-based application 212 may submit a content item request for a content item in response to determining that a user associated with the user device is scheduled to take a flight in three hours. The user device may display a notification 214 that informs the user that a content item is available for viewing.

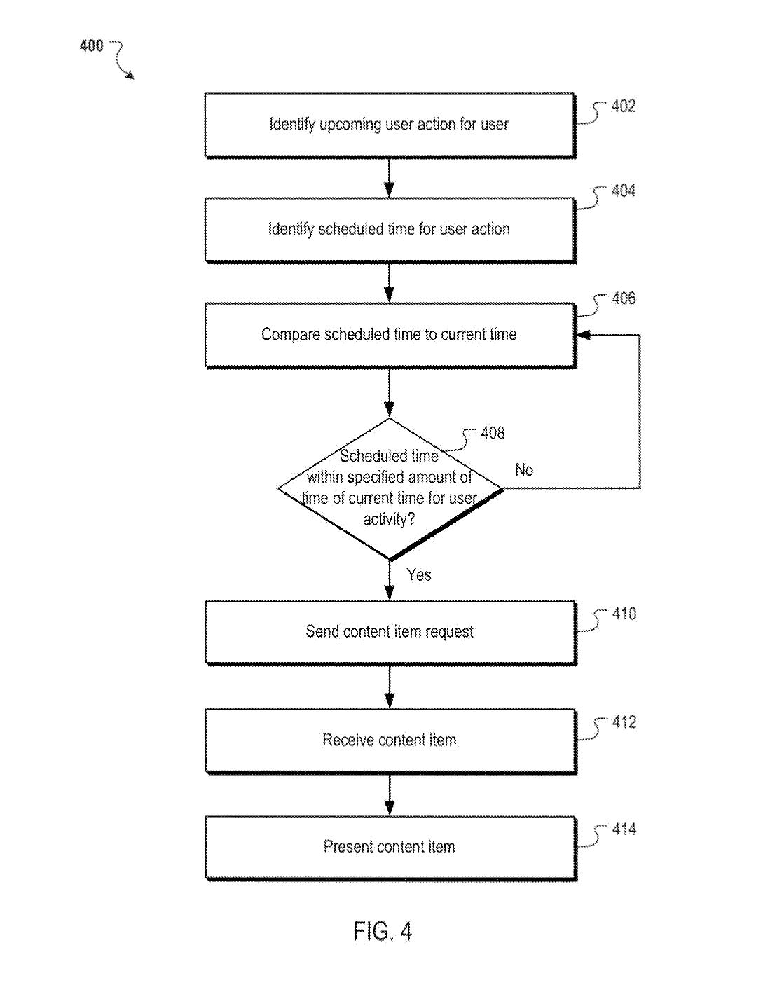

In response to user interaction with the notification 214, the user interface 320 presents the content item 322. In this example, the content item 322 includes a link 324 that links to a resource for downloading an application that enables the user to request a ride to the airport. For example, the content item 322 that includes the link 324 may be presented based on the user's device not having the application installed thereon. FIG. 4 is a flow chart of an example process 400 for requesting and presenting a content item. Operations of the process 400 can be implemented, for example, by a data processing apparatus, such as the user device 105 of FIG. 1. The process 400 can also be implemented by instructions stored on computer storage medium, where execution of the instructions by a data processing apparatus cause the data processing apparatus to perform the operations of the process 400.

An upcoming user action of a user is identified (402). The user action can be identified based on previous user interactions with one or more applications and/or data stored by the one or more applications. For example, if a user has purchased a ticket to a sporting event using a ticket purchasing application executing on a user device, the ticket purchasing application may determine that the user is likely to, or is scheduled to, attend the sporting event.

In some implementations, an application may compare data stored by the application for a user to criteria for a set of predefined user activities to determine whether the user is likely to, or scheduled to, perform a predefined activity in the future. The predefined user activities may be user activities that an application developer has defined for presenting content items. For example, a movie ticket purchasing application may define the user action of going to a movie in two hours as a user action for which a content item (e.g., a content item for a restaurant) may be presented. The movie ticket purchasing application may compare data regarding a user's previous activity (e.g., whether the user has purchased a ticket for a movie) to the criteria for predefined user activities (e.g., the purchase of a ticket for the movie) to determine whether the user's previous activity matches the criteria for a predefined user action. If there is a match, the application may identify the matching predefined activity as an upcoming user action of the user.

A scheduled time for the upcoming user action is identified (404). Continuing the previous movie ticket example, the scheduled time would be the time that the movie is scheduled to start. In some implementations, the scheduled time may be determined by the application. For example, by knowing that the user has a flight at a particular time, the application may estimate that the user will be going to the airport at a particular time.

The application may also use additional data to determine when to request a content item. For example, a travel-based application may have access to traffic data, e.g., by way of the Internet or another application. Using the traffic data and the user's route to the airport, the application may estimate the travel time and use that estimated travel time to determine when to request a content item.

The scheduled time for the upcoming user action is compared to the current time (406). The scheduled time may be compared to the current time to determine how much time there is before the upcoming user action is scheduled to be performed. For example, if the movie is scheduled for 3:00 PM and the current time is noon, then there is three hours between the current time and the scheduled time for the user action.

A determination is made whether the scheduled time is within a specified amount of time of the current time (408). For example, the predefined activity of going to the movie in two hours has a specified amount of time of two hours before the scheduled time of the user action of going to a movie. This specified amount of time can specify when a content item for the user action of going to the movie is to be presented. In this example, a content item for a product or service related to, or that complements, the activity of going to a movie should be presented two hours before the movie. For example, a user may be interested in receiving a coupon for a restaurant near the movie theater two hours before the movie.

If the scheduled time for the user action is not within the specified amount of time of the current time, the process 400 returns to block 406 to monitor for the appropriate time to present a content item for the user action.

If the scheduled time for the user action is within the specified amount of time of the current time, a content item request is sent for the user action (410). For example, the application for which the user action was identified may cause the user device to request a content item based on the user action. The user device may send the content item request to a content distribution system, such as the content distribution system 150 of FIG. 1. As described above, a content item request may include data specifying the user action, a category for the user action, contextual data for the user action or the user device, and/or other appropriate data.

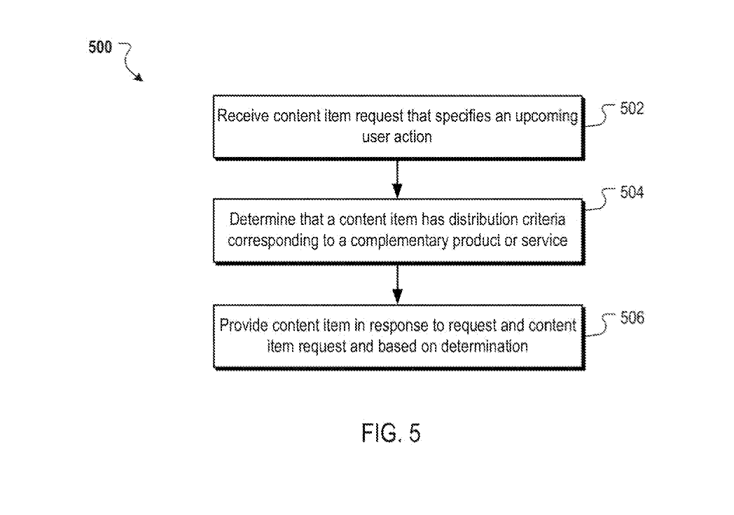

A content item is received in response to the content item request (412). For example, the content distribution system 150 may select a content item based on data included in the content item request and send the selected content item to the user device from which the content item request was sent. An example process for selecting a content item and providing a content item is illustrated in FIG. 5 and described below.

The received content item is presented (414). For example, the content item may be presented at/with the application for which the user activity was identified. In another example, the content item may be presented in/with a different application than the application for which the user action was identified. For example, a movie ticket purchasing may have identified the user action based on the user purchasing a movie ticket using the application. However, the content item may be related to a restaurant application, e.g., an application that allows users to make reservations at restaurants. In this example, the content item may be presented by the restaurant application. If the restaurant application is not installed on the user device that received the content item, a content item that provides a link for the user to download the restaurant application may be presented, e.g., with the received content item.

The application that requested the content item can also provide data to another application, such as the application that presents the content item. For example, a travel-based application may have data that specifies the user's current location and the location of the airport (or other destination). The travel-based application can provide this data to an application for a taxi-service. The taxi application can then use the data to enable the user to request a taxi at the user's current location without the user inputting this data. The data can also be used to identify taxis in the area of the user's current location.

FIG. 5 is a flow chart of an example process 500 for providing a content item. Operations of the process 500 can be implemented, for example, by a data processing apparatus, such as the content distribution system 150 of FIG. 1. The process 500 can also be implemented by instructions stored on computer storage medium, where execution of the instructions by a data processing apparatus cause the data processing apparatus to perform the operations of the process 500.

A content item request is received (502). The content item request may be received from a user device and include data specifying a user action that is likely to, or scheduled to, be performed. The content item request may also include data specifying that the user action is scheduled to be performed at a future time, e.g., that is within a specified amount of time after a current time. For example, the content item request may specify that the user action of attending a concert for a particular musician is scheduled to be performed in two hours from the current time. The content item request can also specify a category for the user action, contextual data for the user action or the user device, and/or other appropriate data. As described above with reference to FIG. 4, the content item request may be sent in response to determining that the user action is scheduled to be performed within a specified amount of time of a current time.

A determination is made that a content item has distribution criteria corresponding to a complementary product or service of the user action (504). A determination may also be made that the distribution criteria for the content item specifies that the content item is eligible to be provided in response to content item requests received during the specified amount of time prior to the future time when the user action is scheduled to be performed. For example, a content distribution system may compare the user action and amount of time specified by the content item request to distribution criteria of a set of content items to identify content items that are eligible to be provided in response to content items that specify the user action and the amount of time. Continuing the previous concert example, the content distribution system may identify content items for complementary products or services that are eligible to be provided in response to content items that specify attendance of a concert within two hours of the current time.

One or more content items may be selected from the set of content items eligible for the user action based on campaign data and/or performance data. The campaign data may specify bids submitted for the user action by advertisers and/or other content item providers. The performance data may specify the performance of the eligible content items, for example, with respect to the user action specified by the content item request or with respect to multiple user actions for which the eligible content items have been provided. The campaign data and performance data may be input to a content item selection process, e.g., a content item auction, to select the content item(s) to provide in response to the content item request. For example, the content item selection process may rank the eligible content items using rank scores for each content item. The rank score for a particular content item may be based on the content item's bid for the user action and/or performance data for the content item. The content item(s) having the highest rank score(s) may be selected.

The selected content item is provided (506). For example, the content item may be provided to a user device that submitted the content item request. The user device may then present the content item to a user.

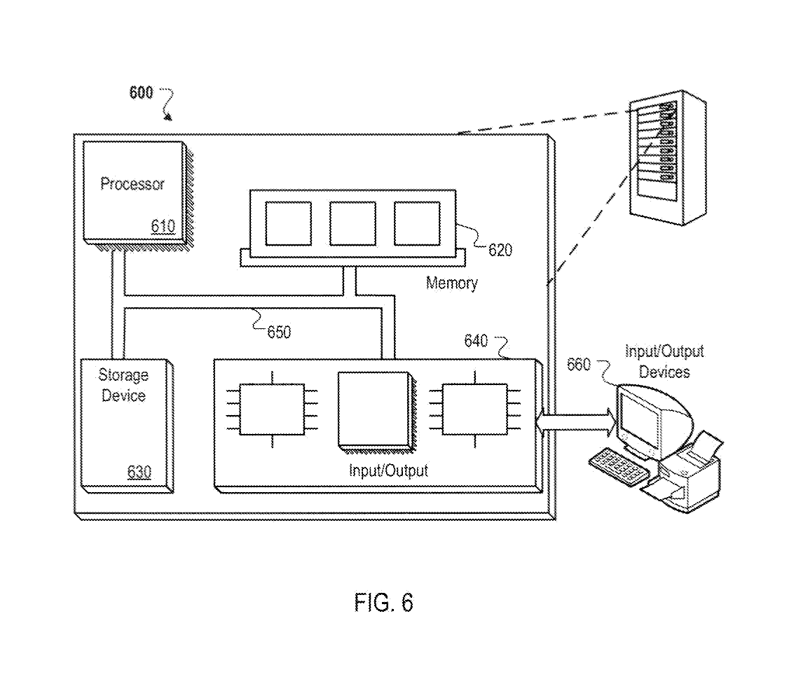

FIG. 6 is a block diagram of an example computer system 600 that can be used to perform operations described above. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 can include, for example, a hard disk device, an optical disk device, a storage device that is shared over a network by multiple computing devices (e.g., a cloud storage device), or some other large capacity storage device.

The input/output device 640 provides input/output operations for the system 600. In one implementation, the input/output device 640 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 560. Other implementations, however, can also be used, such as mobile computing devices, mobile communication devices, set-top box television client devices, etc.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by one or more data processing apparatus, the method comprising:
receiving a content item request specifying an upcoming user action that is scheduled to be performed at a future time that is within a specified amount of time after the content item request is received;
determining, in response to receiving the content item request, that a content item has distribution criteria corresponding to a complementary product or service of the user action and specifying that the content item is eligible to be provided in response to content item requests received during the specified amount of time prior to the future time when the user action is scheduled to be performed; and
providing, in response to the content item request and based on the determination, the content item for presentation at a user device.

2. The method of claim 1, further comprising:
receiving data specifying the user action and the specified amount of time;
providing the data to one or more content item providers; and
receiving, from at least one of the content item providers, distribution criteria specifying a bid for providing a content item of the at least one content item provider in response to content item requests that specify that the user action and that are received during the specified amount of time prior to a future time when the user action is scheduled to be performed by a user; and
selecting the content item based at least on the received distribution criteria.

3. The method of claim 1, wherein the user action comprises attending an event, the method further comprising selecting, based on at least one of the event and a role of the user with respect to the event, the content item from a set of content items that have distribution criteria corresponding to a complementary product or service.

4. The method of claim 1, wherein:
determining that the user action is scheduled to be performed based on previous user actions performed with respect to a first application; and
determining that the content item is eligible to be provided by a second application that is different from the first application,
wherein the content item presents a link to install the second application in response to determining that the second application is not installed on the user device.

5. The method of claim 1, wherein:
providing the content item comprises providing data that causes a notification of the content item to be displayed at the user device; and
interaction with the notification causes the content item to be displayed at the user device.

6. The method of claim 1, further comprising determining that the user action is scheduled to be performed based on scheduled attendance at an event at a particular time.

7. The method of claim 1, wherein:
the content item request is initiated by an application in response to determining that the user action is scheduled to be performed based on previous user interaction with the application; and
the user action is an offline user action performed without use of the application or the user device.

8. A system, comprising:
a data processing apparatus; and
a memory storage apparatus in data communication with the data processing apparatus, the memory storage apparatus storing instructions executable by the data processing apparatus and that upon such execution cause the data processing apparatus to perform operations comprising:
receiving a content item request specifying an upcoming user action that is scheduled to be performed at a future time that is within a specified amount of time after the content item request is received;
determining, in response to receiving the content item request, that a content item has distribution criteria corresponding to a complementary product or service of the user action and specifying that the content item is eligible to be provided in response to content item requests received during the specified amount of time prior to the future time when the user action is scheduled to be performed; and
providing, in response to the content item request and based on the determination, the content item for presentation at a user device.

9. The system of claim 8, wherein the operations further comprise:
receiving data specifying the user action and the specified amount of time;
providing the data to one or more content item providers;
receiving, from at least one of the content item providers, distribution criteria specifying a bid for providing a content item of the at least one content item provider in response to content item requests that specify that the user action and that are received during the specified amount of time prior to a future time when the user action is scheduled to be performed by a user; and
selecting the content item based at least on the received distribution criteria.

10. The system of claim 8, wherein the user action comprises attending an event, the operations further comprising selecting, based on at least one of the event and a role of the user with respect to the event, the content item from a set of content items that have distribution criteria corresponding to a complementary product or service.

11. The system of claim 8, further comprising:
determining that the user action is scheduled to be performed based on previous user actions performed with respect to a first application; and
determining that the content item is eligible to be provided by a second application that is different from the first application,
wherein the content item presents a link to install the second application in response to determining that the second application is not installed on the user device.

12. The system of claim 8, wherein:
providing the content item comprises providing data that causes a notification of the content item to be displayed at the user device; and
interaction with the notification causes the content item to be displayed at the user device.

13. The system of claim 8, wherein the operations further comprise determining that the user action is scheduled to be performed based on scheduled attendance at an event at a particular time.

14. The system of claim 8, wherein:
the content item request is initiated by an application in response to determining that the user action is scheduled to be performed based on previous user interaction with the application; and
the user action is an offline user action performed without use of the application or the user device.

15. A computer storage medium encoded with a computer program, the program comprising instructions that when executed by a data processing apparatus cause the data processing apparatus to perform operations comprising:
receiving a content item request specifying an upcoming user action that is scheduled to be performed at a future time that is within a specified amount of time after the content item request is received;
determining, in response to receiving the content item request, that a content item has distribution criteria corresponding to a complementary product or service of the user action and specifying that the content item is eligible to be provided in response to content item requests received during the specified amount of time prior to the future time when the user action is scheduled to be performed; and
providing, in response to the content item request and based on the determination, the content item for presentation at a user device.

16. The computer storage medium of claim 15, wherein the operations further comprise:
receiving data specifying the user action and the specified amount of time;
providing the data to one or more content item providers;
receiving, from at least one of the content item providers, distribution criteria specifying a bid for providing a content item of the at least one content item provider in response to content item requests that specify that the user action and that are received during the specified amount of time prior to a future time when the user action is scheduled to be performed by a user; and
selecting the content item based at least on the received distribution criteria.

17. The computer storage medium of claim 15, wherein the user action comprises attending an event, the operations further comprising selecting, based on at least one of the event and a role of the user with respect to the event, the content item from a set of content items that have distribution criteria corresponding to a complementary product or service.

18. The computer storage medium of claim 15, wherein the operations further comprise:
determining that the user action is scheduled to be performed based on previous user actions performed with respect to a first application; and
determining that the content item is eligible to be provided by a second application that is different from the first application,
wherein the content item presents a link to install the second application in response to determining that the second application is not installed on the user device.

19. The computer storage medium of claim 15, wherein:
providing the content item comprises providing data that causes a notification of the content item to be displayed at the user device; and
interaction with the notification causes the content item to be displayed at the user device.

20. The computer storage medium of claim 15, wherein the operations further comprise determining that the user action is scheduled to be performed based on scheduled attendance at an event at a particular time.
